(19) United States
(12) Patent Application Publication
(10) Pub. No.: US 2021/0340291 A1
(43) Pub. Date: Nov. 4, 2021

(54) METHODS OF SYNTHESIZING POLYMERS

(71) Applicant: King Abdullah University of Science and Technology, Thuwal (SA)

(72) Inventors: Konstantinos NTETSIKAS, Thuwal (SA); Georgios POLYMEROPOULOS, Thuwal (SA); Georgios ZAPSAS, Thuwal (SA); Panagiotis BILALIS, Thuwal (SA); Yves GNANOU, Thuwal (SA); Nikolaos HADJICHRISTIDIS, Thuwal (SA)

(21) Appl. No.: 17/255,648

(22) PCT Filed: Jul. 16, 2019
(86) PCT No.: PCT/IB2019/056076

§ 371 Date: Dec. 23, 2020

Related U.S. Application Data
(60) Provisional application No. 62/698,561, filed on Jul. 16, 2018.
(60) Provisional application No. 62/723,657, filed on Aug. 28, 2018.
(60) Provisional application No. 62/760,397, filed on Nov. 13, 2018.

(51) Int. Cl. C08F 112/08; C08F 297/04

(52) U.S. Cl. CPC C08F 112/08; C08F 2410/01; C08F 297/04

(57) ABSTRACT

Embodiments of the present disclosure describe a method of synthesizing a polymer comprising contacting a first monomer and an organolithium initiator in a nonpolar solvent and adding a promoter to the nonpolar solvent to polymerize the first monomer. Embodiments of the present disclosure further describe a method of synthesizing a polymer comprising contacting a first monomer and an organolithium initiator in a nonpolar solvent, adding a promoter to the nonpolar solvent to polymerize the first monomer, and adding a second monomer to the nonpolar solvent to polymerize the second monomer.

### BACKGROUND

The living anionic polymerization was discovered and reported in two seminal papers by Michael Szwarc and coworkers in 1956, working on the polymerization of styrene with sodium napthalenide as initiator, in tetrahydrofuran (THF). Since its discovery, it has emerged as the most powerful tool for the synthesis of well-defined polymers with narrow molecular weight distribution and controlled molecular characteristics (molecular weight, composition, microstructure, and architecture). The ability of anionic polymerization to form well-defined polymers is mainly due to the absence of termination and chain transfer reactions. Additionally, it inspired many researchers to develop controlled/living strategies for a plethora of monomers including those which not compatible with anionic polymerization.

The unique aspect of control in living anionic polymerization motivated tremendous academic and industrial research activity. This led to the development of numerous technologies for the synthesis of important commodity and specialized materials. Although anionic polymerization is a demanding methodology and cannot tolerate many functional groups, it works exceptionally well with important monomers such as styrene, 1,3-butadiene, and isoprene, which are found in many commercial applications. It holds a leader position in the industrial production of polydiene rubbers, styrene/butadiene rubbers (SBR) and thermoplastic elastomers of styrenic type that are used in a number of industries such as automotive, building and construction, footwear, medical, wires and cables.

Anionic polymerization proceeds via organometallic sites, carbanions (or oxanions) with metallic counterions. Among others, organolithiums are the most widely used initiators. The main requirement for the employment of an organometallic compound as the initiator is its rapid reaction with the monomer at the initiation step of the polymerization, and specifically with a higher reaction rate than the propagation step. Slow initiation followed by rapid propagation broadens the molecular weight distribution of the resulting polymers. This undesired broadening can be eliminated by the use of the “seeding technique.” In this method, the initiator is reacted with a small amount of monomer, the mixture is left for a while to form oligomers and subsequently, the rest of the monomer is added. These oligomers will grow uniformly upon the addition of the remaining monomer and produce polymers with narrow molecular weight distribution.

It is widely known that the rate of polymerization of styrene initiated by carbanionic initiators is accelerated in the presence of additives such as Lewis bases (ethers or amines). Generally, additives exhibit a high solvating power and can induce the solvation of ion pairs. Moreover, they cause the disaggregation of aggregated ion pairs and are used either for fast initiation or to accelerate the rate of polymerization of several monomers. Especially in the case of polydienes (polybutadiene and polyisoprene), additives can alter the microstructure of the final polymers, enhancing their vinyl content.

In addition to ethers and amines, phosphazene superbases (PBs), a category of neutral Brönsted bases have been used as additives in anionic polymerization and more extensively as effective organic catalysts for the polymerization of several types of monomers (epoxides, cyclosiloxanes, cyclic esters etc.). The main feature of these non-nucleophilic bases is their high basicity (26<pKₐ<43 in acetonitrile). There is an increase in basicity with an increased number of P atoms (P₁ to P₄), due to a rise in the delocalization of the charge on the conjugated phosphazenium cation. Furthermore, phosphazene bases are commercially available, chemically and thermally stable and soluble in common non-polar and polar solvents (hexane, toluene, and THF). In general, phosphazene bases enhance the nucleophilicity of the initiator/chain-end significantly by complexation with the counterion (e.g., proton or lithium cation), resulting in a rapid anionic polymerization.

In previous work of the Applicants, the anionic polymerization of styrene and 1,3-butadiene utilizing different phosphazene bases (t-BuP₁, t-BuP₂, and t-BuP₄) as organic catalysts in a non-polar solvent at room temperature was investigated. When t-BuP₁ was used, the polymerization proceeded in a controlled manner, whereas the obtained homopolymers exhibited the desired molecular weights and narrow polydispersity (Ð<1.05). In the case of t-BuP₂, homopolymers with higher molecular weights than the theoretical ones and relatively low polydispersity were obtained. Finally, in the presence of t-BuP₄, the polymerization of styrene was uncontrolled due to the high reactivity of the formed carbanion.

### SUMMARY

In general, embodiments of the present disclosure describe methods of synthesizing polymers, such as homopolymers and copolymers.

Embodiments of the present disclosure describe a method of synthesizing a polymer comprising contacting a first monomer and an organolithium initiator in a nonpolar solvent and adding a promoter to the nonpolar solvent to polymerize the first monomer.

Embodiments of the present disclosure further describe a method of synthesizing a polymer comprising contacting a first monomer and an organolithium initiator in a nonpolar solvent, adding a promoter to the nonpolar solvent to polymerize the first monomer, and adding a second monomer to the nonpolar solvent to polymerize the second monomer.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of synthesizing a polymer, according to one or more embodiments of the present disclosure.

FIG. 2 is a flowchart of a method of synthesizing a polymer, according to one or more embodiments of the present disclosure.

FIGS. 3A-3D are graphical views of monitoring the polymerization of styrene by SEC of withdrawn aliquots obtained at different time intervals during the polymerization using: A. [t-BuP₄]/[sec-BuLi]:2.5/1. B: [t-BuP₄]/[sec-BuLi]:5/1. C. [t-BuP4]/[sec-BuLi]:10/1. D. [t-BuP₄]/[sec-BuLi]:20/1, according to one or more embodiments of the present disclosure.

FIGS. 4A-4B are graphical views of A) Monitoring the polymerization of styrene via “seeding” and t-BuP₄ by SEC of withdrawn aliquots obtained at different time intervals (Table 1, PS-1, Entry 1); B)¹H-NMR spectra taken 2 min after the initiation of the polymerization of styrene to form the “seeds” and 5 min (100% conversion) after the addition of t-BuP₄, according to one or more embodiments of the present disclosure.

FIG. 5 is a graphical view of a MALDI-ToF spectrum of polystyrene synthesized via “seeding” and t-BuP₄ as additive (Table 1, Entry 1), according to one or more embodiments of the present disclosure.

FIGS. 6A-6B are graphical views of A) Monitoring the polymerization of styrene via “seeding” and t-BuP₂ by SEC of withdrawn aliquots obtained at different time intervals; B)¹H-NMR spectra taken 2 min after the initiation of the polymerization of styrene to form the “seeds” and 30 min (100% conversion) after the addition of t-BuP₂, according to one or more embodiments of the present disclosure.

FIG. 7 is a graphical view of SEC traces obtained from withdrawn aliquots at different time intervals during the polymerization of styrene via seeding with t-BuP₁ (Table 2, Entry 1), according to one or more embodiments of the present disclosure.

FIG. 8 is a graphical view of SEC traces obtained from withdrawn aliquots at different time intervals during the polymerization of styrene via seeding with TMEDA (Table 2, Entry 3), according to one or more embodiments of the present disclosure.

FIGS. 9A-9B are graphical views of A) Monitoring the polymerization of 4-methylstyrene via “seeding” and t-BuP₄ by SEC of withdrawn aliquots obtained at different time intervals; B)¹H-NMR spectra taken 2 min after the initiation of the polymerization of 4-methylstyrene and 5 min (100% conversion) after the addition of t-BuP₄, according to one or more embodiments of the present disclosure.

FIG. 10 is a graphical view of SEC traces obtained from withdrawn aliquots at different time intervals during the polymerization of 1,3-butadiene via seeding with t-BuP₄, according to one or more embodiments of the present disclosure.

FIG. 11 is a graphical view of monitoring the polymerization of styrene initiated by a “living” PS synthesized via seeding and t-BuP₄, according to one or more embodiments of the present disclosure.

FIG. 12 is a graphical view of SEC traces of PS synthesized via “seeding” and t-BuP₄ and PS-b-PB copolymer after sequential addition of 1,3-butadiene, according to one or more embodiments of the present disclosure.

FIGS. 13A-13B are graphical views of A) Monitoring the copolymerization of PS-b-PB (PS macroinitiator via “seeding” and t-BuP₂ by SEC of withdrawn aliquots obtained at different time intervals; B)¹H-NMR spectra taken 30 min after the addition of t-BuP₂ and of PS-b-PB final product, according to one or more embodiments of the present disclosure.

FIGS. 14A-14B are graphical views of A) SEC traces obtained from withdrawn aliquots at different time intervals during the copolymerization of PS-b-PB (PS macroinitiator via seeding with t-BuP₁), B)¹H-NMR spectra of PS 2 h after the addition of t-BuP₁ and of PS-b-PB final product (Table 3, Entry 4), according to one or more embodiments of the present disclosure.

FIGS. 15A-15B are graphical views of A) Monitoring the polymerization of styrene initiated by a “living” polybutadiene and addition of t-BuP₄ after 10 min by SEC of withdrawn aliquots obtained at different time intervals; B)¹H-NMR spectra taken 10 min, 30 min and 1 h after the addition of t-BuP₄ to a solution with “living” polybutadiene and St, according to one or more embodiments of the present disclosure.

### DETAILED DESCRIPTION

Embodiments of the present disclosure relate to novel methods of synthesizing polymers. In particular, embodiments of the present disclosure relate to novel methods of synthesizing polymers in which a “seeding” technique and a promoter are used to achieve ultrafast and controlled anionic polymerization of one or more monomers. For example, the “seeding” technique may be used to at least balance the rates of initiation and propagation such that polymers with narrow molecular weight distributions may be synthesized. The promoter may be used to accelerate the rate of propagation by, for example, generating a free ion on a propagating species. Upon consuming the monomer, the polymerization may remain “living” such that an additional monomer may be added to form copolymers by sequential monomer addition. The polymerization reactions may proceed under moderate conditions to achieve polymers in a fraction of the time it takes conventional methods, with narrow molecular weight distributions and highly predictable molecular weights.

In anionic polymerization, it is generally undesirable to observe a rate of propagation that is greater than a rate of initiation (e.g., a rate of initiation that is slow relative to a rate of propagation). This is because such an imbalance frequently leads to uncontrollable polymerization. For example, a slower rate of initiation may result in the formation of active species at different points during propagation, broadening the molecular weight distribution of the resulting polymers due to differences in the degree of polymerization. Accordingly, the methods of the present disclosure may employ a “seeding” technique to control the rate of initiation, such that it is at least balanced with, or greater than, the rate of propagation. This provides greater control over the polymerization and resulting polymers because a greater or at least balanced rate of initiation allows the active species to form in the early stages of the polymerization reaction. Propagation may then proceed about uniformly (e.g., at about the same time and/or rate) to obtain polymers with the same or similar degrees of polymerization and narrow molecular weight distributions.

In addition, conventional methods may suffer from competitive side reactions. For example, the polymerization of alkyl-substituted styrenes, such as methyl styrene, must be performed at −78° C. in order to promote initiation of the carbon-carbon double bond and not of the methyl substituent. Accordingly, such methods may require, among other things, very low temperatures in order to minimize such undesirable side reactions (e.g., with the methyl substituent of methyl styrene). The temperatures required to be effective may even reach as low as about −80° C. to about 0° C., greatly increasing costs. The methods of the present disclosure, however, may be performed under moderate conditions, such as about room temperature, without observing any undesirable side reactions or at least any products thereof in any appreciable amount. For example, in an embodiment, the polymerization reactions may proceed so quickly that the undesirable side reactions do not even have an opportunity to occur.

Accordingly, the methods of synthesizing polymers described herein may comprise an initiation step and a propagation step. For example, in the initiation step, a first monomer (e.g., styrenic monomers and other monomers, such as conjugated dienes, etc.) may be contacted with an organolithium initiator in a presence of a nonpolar solvent to form oligomers as “seeds,” but not the final polymer. The oligomers may include an anionic propagating species having a lithium counterion. Upon forming the “seeds,” propagation may then be accelerated by the addition of a promoter. For example, a promoter, such as a phosphazene base, may be added to the nonpolar solvent to accelerate the rate of propagation by complexing with the lithium counterion and generating a solvated and/or free ion (e.g., anion) that is highly active in the polymerization. The reaction may proceed with the oligomers growing about uniformly through chain propagation to produce well-defined polymers. In the absence of a quenching agent, the polymers may remain “living,” such that a second monomer, which is typically different from (but may be the same as) the first monomer, may optionally be added to the nonpolar solvent to form a copolymer by, for example, sequential monomer addition. The polymerization of a second monomer may proceed in a manner this is similar to or the same as the polymerization of the first monomer.

In this way, the methods of the present disclosure may be used for ultrafast phosphazene-promoted controlled anionic polymerizations of one or more monomers, including, but not limited to, styrenic monomers and other monomers, such as conjugated diene monomers. The methods described herein may achieve a conversion (e.g., monomer conversion) of about 99% or greater in about 5 min or less, which is unprecedented. The methods described herein may provide control over the polymerizations such that polymers with narrow molecular weight distributions and highly predictable molecular weights may be synthesized. The methods described herein may proceed under mild conditions, such as about room temperatures, without observing any products from undesirable side reactions (e.g., as in the case of alkyl-substituted styrenes, among other types of monomers). The methods described herein may achieve polymerizations in which a rate of initiation is greater than (e.g., much greater than) the rate of propagation.

The methods of the present disclosure are appealing for at least the following reasons: high-demand materials like polystyrene and functionalized polystyrenes may be produced in minutes by anionic polymerization, after the addition of small amounts of a commercially available reagent; the mechanical properties of the produced materials may be fine-tuned since they are well-defined (narrow polydispersity, predictable molecular weight, etc.); the conversion of the polymerization is quantitative (e.g., >99%), meaning that no extra procedures for removing the unreacted monomers may be necessary; and well-defined block copolymers may be synthesized in minutes leading to new materials with adjustable properties.

### Definitions

The terms recited below have been defined as described below. All other terms and phrases in this disclosure shall be construed according to their ordinary meaning as understood by one of skill in the art.

As used herein, “contacting” refers to the act of touching, making contact, or of bringing to close or immediate proximity, including at the cellular or molecular level, for example, to bring about a physiological reaction, a chemical reaction, or a physical change (e.g., in solution, in a reaction mixture, in vitro, or in vivo). Contacting may refer to bringing two or more components in proximity, such as physically, chemically, electrically, or some combination thereof. “Adding” is an example of contacting.

As used herein, the term “styrenic” refers to any styrene and/or styrene derivative. A styrene derivative may include a functionalized and/or substituted styrene in which at least one hydrogen group is substituted for an alkyl (e.g., alkyl functionalized/substituted styrenes). The alkyl may be linear or branched having 1 to 20 carbon atoms.

An used herein, “organolithium” refers to any compound in which a carbon atom of an organic compound or molecule, such as a functional group R, is bonded to a lithium atom. The functional group R may represent, for example, aliphatic, alicyclic or aromatic hydrocarbon radicals. The number of carbon atoms of R is not particularly limited. Examples of suitable R groups include, but are not limited to, one or more of alkyls, alkenyls, cycloalkyls, aryls, alkaryls, aralkyls and the like.

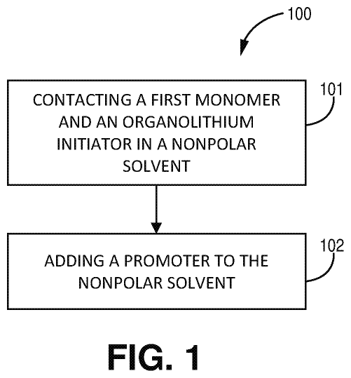

FIG. 1 is a flowchart of a method of synthesizing polymers, according to one or more embodiments of the present disclosure. As shown in FIG. 1, the method 100 may comprise contacting 101 a first monomer and an organolithium initiator in a nonpolar solvent and adding 102 a promoter to the nonpolar solvent. In an embodiment, the promoter and organolithium initiator are provided in about equimolar amounts.

The step 101 includes contacting a first monomer and an organolithium initiator in a nonpolar solvent to initiate anionic polymerization and form oligomers. In this step, an organolithium initiator and a first monomer may be contacted in a nonpolar solvent to generate oligomers as seeds. While not wishing to be bound to a theory, the oligomers that are formed may include a propagating center that is active for polymerizations, such as anionic polymerization and/or living anionic polymerization. The propagating center of the oligomer may include a propagating anionic species (e.g., a propagating anionic chain end(s)) having a lithium counterion from the initiator, such as Li⁺. The propagating anionic species and lithium counterion may form aggregated ion pairs, such as one or more of an intimate ion pair and solvent-separated ion pair. An intimate ion pair may not be separated by any solvent and a solvent-separated ion pair may be partially separated by solvent. The reaction rate of the organolithium initiator and the first monomer (e.g., rate of initiation) may be greater than (e.g., much greater than) the rate of propagation such that the oligomers grow about uniformly to produce polymers with narrow molecular weight distributions, among other things.

The contacting may be controlled to promote formation of oligomers. For example, in an embodiment, it may be desirable to control the contacting such that an oligomer is formed, but not the final polymer or at least a polymer is not formed in any appreciable amount. To promote formation of the oligomer, but not of the final polymer, the contacting may proceed for a duration sufficient to control the initiation. For example, in an embodiment, the duration may be at least about 1 min.

The contacting may further proceed at or to a select temperature. At least one of the many benefits of the methods described herein is that the polymerizations (e.g., initiation and/or propagation) may proceed at moderate temperatures, among other temperatures. For example, conventional methods may require low temperatures (e.g., ranging from about −80° C. to about 0° C.) for certain polymerizations in order to minimize undesirable side reactions. As one example, the polymerization of alkyl substituted styrenes, such as methyl styrene, must be performed at −78° C. in order to promote initiation of the carbon-carbon double bond of styrene and not of the methyl substituent. However, while the polymerizations described herein may be performed at such temperatures, the polymerizations may also be performed at moderate temperatures, such as about room temperature, without observing undesirable side reactions or at least any products thereof in any appreciable amount. While not wishing to be bound to a theory, it is believed that the rate of polymerization (e.g., initiation and/or propagation) is sufficiently greater (e.g., much greater) than the rate of any undesirable side reactions such that the latter do not even have an opportunity to occur.

The first monomer may generally include styrenic monomers and other monomers capable of being initiated by the organolithium initiator. For example, the first monomer may include any styrenic monomer. In an embodiment, the styrenic monomers may include styrene. In an embodiment, the styrenic monomers may include alkyl-substituted styrenes. Examples of alkyl-substituted styrenes include, but are not limited to, one or more of 4-methylstyrene; alpha-methylstyrene; 1-vinylnaphthalene; 2-vinylnaphthalene; 1-alpha-methylvinylnaphthalene; 2-alpha-methylvinylnaphthalene; 1,2-diphenyl-4-methylhexane-1; 1,6-diphenyl-hexadiene-1,5; 1,3-divinylbenzene; 1,3,5-trivinylbenzene; 1,3,5-triisopropenylbenzene; 1,4-divinylbenzene; 1,3-distyrylbenzene; 1,4-distryrylbenzene; 1,2-distyrylbenzene; and mixtures of these, as well as alkyl, cycloalkyl, aryl alkaryl and aralkyl derivatives thereof in which the total number of carbon atoms in the combined hydrocarbon constitutes generally not greater than 12. Examples of these latter compounds include: 3-methylstyrene; 3,5-diethylstyrene; 2-ethyl-4-benzylstyrene; 4-phenylstyrene; 4-p-tolylstyrene; 2,4-divinyltoluene; 4,5-dimethyl-1-vinylnaphthalene; 2,4,6-trivinyltoluene; 2,4,6-triisopropenyltoluene, and the like.

In addition or in the alternative, the first monomer may include other monomers capable of being initiated by the organolithium initiator. For example, in an embodiment, the first monomer may include dienes, such as conjugated dienes. In an embodiment, the first monomer may include one or more of 1,3-butadiene, isoprene, 2,3-dimethyl-1,3-butadiene, 1,3-pentadiene (piperylene), 2-methyl-3-ethyl-1,3-butadiene, 3-methyl-1,3-pentadiene, 2-methyl-3-ethyl-1,3-pentadiene, 2-ethyl-1,3-pentadiene, 1,3-hexadiene, 2-methyl-1,3-hexadiene, 1,3-heptadiene, 3-methyl-1,3-heptadiene, 1,3-octadiene, 3-butyl-1,3-octadiene, 3,4-dimethyl-1,3-hexadiene, 3-n-propyl-1,3-pentadiene, 4,5-diethyl-1,3-octadiene, phenyl-1,3-butadiene, 2,3-diethyl-1,3-butadiene, 2,3-di-n-propyl-1,3-butadiene, 2-methyl-3-isopropyl-1,3-butadiene, and the like.

The amount of the first monomer and/or the molar ratio of the monomer to initiator may be varied to achieve a desired degree of polymerization and/or molecular weight of the resulting polymer.

The organolithium initiator may include one or more of n-butyllithium, sec-butyllithium, tert-butyllithium, methyllithium, ethyllithium, n-propylllithium, isopropyllithium, n-butyllithium, isobutyllithium, sec-butyllithium, tert-butyllithium, n-amyllithium, isoamyllithium, n-pentyllithium, n-hexyllithium, 2-ethylhexyllithium, n-octyllithium, n-decyllithium, stearyllithium, allyllithium, n-propenyllithium, isobutenyllithium, 1-cyclohexenyllithium, cyclopentyllithium, cyclohexyllithium, cyclohexylethyllithium, phenyllithium, naphthyllithium, vinyl lithium, tolyllithium, butylphenyllithium, benzyllithium, phenylbutyllithium, tetramethylenedilithium, pentamethylenedilithium, hexamethylenedilithium, diphenylethylenedilithium, tetraphenylethylenedilithium, 1,5-dilithium naphthalene, 1,20-dilithioeicosane, 1,4-dilithiocyclohexane, dilithiostylbene and the like. The organolithium compounds containing an inert functional group to polymerization may also be used. A mixture of two or more of the above described organolithium compounds may also be used.

Any nonpolar solvent may be used. Examples of nonpolar solvents include, but are not limited to, one or more of benzene, cyclohexane, toluene, hexane, pentane, and cyclopentane. In other embodiments, a polar solvent may be used. In these embodiments, it may be desirable for the contacting to proceed at a temperature lower than about room temperature, such as about 0° C. or less.

The step 102 includes adding a promoter to the nonpolar solvent. In this step, the promoter is added to the nonpolar solvent (which may include one or more of the species present in the step 101, e.g., at least the oligomer and optionally one or more of the organolithium initiator, first monomer, etc.) to accelerate chain propagation and form the final polymer. While not wishing to be bound to a theory, upon the addition of the promoter, the promoter may disaggregate the aggregated ion pair. For example, in an embodiment, the promoter may complex with the lithium counterion. This complexation of the promoter and lithium counterion may liberate the propagating anionic species from the lithium counterion and generate a completely free anion (e.g., a solvated or highly solvated ion or anion) that is highly reactive in anionic polymerization relative to the aggregated ion pair. In this way, the addition of the promoter and its complexation with the lithium counterion may accelerate the rate of propagation by liberating the propagating anion at the chain ends of the oligomers and/or growing polymer chains.

The adding is an example of a form of contacting. For example, adding the promoter to the nonpolar solvent may include bringing the promoter and at least the oligomer, and optionally one or more of the other species present in the nonsolvent, into physical contact and/or immediate or close proximity. The adding may proceed in any order. For example, in an embodiment, the promoter may be added to the nonpolar solvent, which may include one or more of the species present in the step 101 (e.g., at least the oligomer and optionally one or more of the organolithium initiator, first monomer, etc.). In an embodiment, the nonpolar solvent, which may similarly include one or more of the species present in the step 101, may be added to the promoter. The adding (e.g., and polymerization) may proceed under conditions that are the same as or similar to the contacting in step 101. For example, the adding may proceed at any suitable temperature, such as about room temperature.

Once a period of time sufficient to control the initiation has passed, the promoter may be added. For example, the point at which the promoter is added may range from about 1 min after the initiation has started to about 5 min before the end of the reaction. In an embodiment, the promoter is added at least about 1 min after the initiation has started (e.g., after the contacting step 101 is performed), as about 1 min would be sufficient to control the initiation. In an embodiment, the promoter is added no later than about 5 min before the end of the reaction, as the reaction typically is completed in about 5 min once the promoter is added.

The promoter may include Lewis bases and/or Brönsted bases. For example, the promoter may include phosphazene superbases. In an embodiment, the promoter may include one or more of t-BuP₄, t-BuP₂, t-BuP₁, cyclic trimeric phosphazene base (CTPB), t-BuP₃ (branched or linear), t-BuP₅ (branched or linear), PyP₄, and t-BuP₇. The amount of the promoter added to the nonpolar solvent is generally at least about equal (e.g., equimolar) to the organolithium initiator. In many embodiments, the promoter and organolithium initiator are added in equimolar amounts. In some embodiments, providing an excess of the promoter relative to the organolithium initiator by increasing the molar ratio of the promoter to organolithiuim above 1:1 may not affect the polymerization and/or any part thereof (e.g., initiation, propagation, etc.). Accordingly, a molar ratio of the promoter to the organolithium initiator should generally be at least about 1 (e.g., an equimolar amount of the promoter and organolithium initiator). In other embodiments, a molar ratio of the promoter to the organolithium initiator may range from about 100:1 to about 1:1. For example, in an embodiment, the molar ratio of the promoter to the organolithium initiator may be about 2.5:1, about 5:1, about 10:1, or about 20:1.

The addition of the promoter accelerates the rate of propagation (e.g., chain propagation). An appropriate balance between the rate of initiation and rate of propagation may be maintained and/or preserved using the methods of the present disclosure (e.g., by forming oligomer seeds first and subsequently adding the promoter). For example, while the rate of propagation may be accelerated, the rate of initiation may remain greater than or at least balanced with the rate of propagation. This ability to maintain the balance between the rates of the initiation and of propagation may be a product of the controlled formation of the initiating species, wherein the first monomer and organolithium initiator are allowed to form oligomers as “seeds” but not polymers, combined with the addition of the promoter to accelerate the rate of propagation. In this way, the methods of the present disclosure may achieve polymers with narrow molecular weight distributions and highly predictable molecular weights by anionic polymerization.

Upon the addition of the promoter, the polymerization may be allowed to proceed until the first monomer is consumed. In an embodiment, the polymerization is allowed to proceed until the first monomer is substantially and/or completely consumed. In an embodiment, the polymerization is allowed to proceed until the monomer is partially consumed. Surprisingly, in an embodiment, a conversion of greater than 99% may be achieved in a fraction of the time it takes conventional processes to achieve nearly full conversion of monomers, which may take hours to realize. While convention processes for the anionic polymerization of styrene in hydrocarbon solvents at room temperature take more than 3 h, the methods of the present disclosure may achieve a conversion of greater than 99% in hydrocarbon solvents at room temperature in about 5 min or less. In some embodiments, a conversion of greater than about 99% may be achieved in about 150 min or less, such as about 130 min or less, 110 min or less, and/or about 30 min or less, which is still less than conventional methods.

The addition of the promoter may also minimize and/or eliminate competitive side reactions, which may be undesirable. For example, through the addition of the promoter, propagation may proceed at the active center at such an accelerated rate that the side reactions do not have an opportunity to occur. In such instances, the rate of propagation may be greater (e.g., much greater) than the reaction rate of competitive side reactions. This may be a useful feature of the methods of the present disclosure where functionalized and/or substituted first monomers with reactive groups are used. A non-limiting example of such a first monomer is an alkyl-substituted styrenic monomer.

The molecular weight distributions of the resulting polymers may be narrow. For example, the molecular weight distribution of the resulting polymers may be about 1.10 or less. In an embodiment, the molecular weight distribution of the resulting polymer may be about 1.10 or less, about 1.09 or less, about 1.08 or less, about 1.07 or less, about 1.06 or less, about 10.5 or less, about 1.04 or less, about 1.03 or less, about 1.02 or less, about 1.01 or less, or about 1.00. In other embodiments, the molecular weight distribution of the resulting polymers may be about 1.40 or less. The experimental molecular weights of the resulting polymers may be the same as or similar to their theoretical molecular weights. For example, in an embodiment, the experimental molecular weight of the resulting polymers is within about 2% to about 3% of the theoretical or target molecular weight. In other embodiments, the experimental molecular weight of the resulting polymers is within about 10% or less of the theoretical or target molecular weight.

By allowing the polymerization to proceed until the first monomer is consumed, the methods of the present disclosure may be used to polymerize homopolymers of the first monomers. In one embodiment, a quenching agent may optionally be added to terminate the growing polymer chain. In another embodiment, chain growth of the resulting polymer may be allowed to continue by adding additional amounts of the first monomer and/or adding a second monomer. For example, the chain end of the resulting polymer may be “living,” even following consumption of the first monomer, such that a second monomer may be added to synthesize copolymers (e.g., block copolymers) by sequential monomer addition. Surprisingly, the addition of the second monomer may form copolymers with the same (e.g., or similar) narrow molecular weight distributions, predictable molecular weights, and high conversions, among other things, as the polymers synthesized from the first monomer.

In an embodiment, the general reaction scheme for the anionic polymerization of styrenic derivatives via “seeding” technique in the presence of t-BuP₄ may be represented as follows:

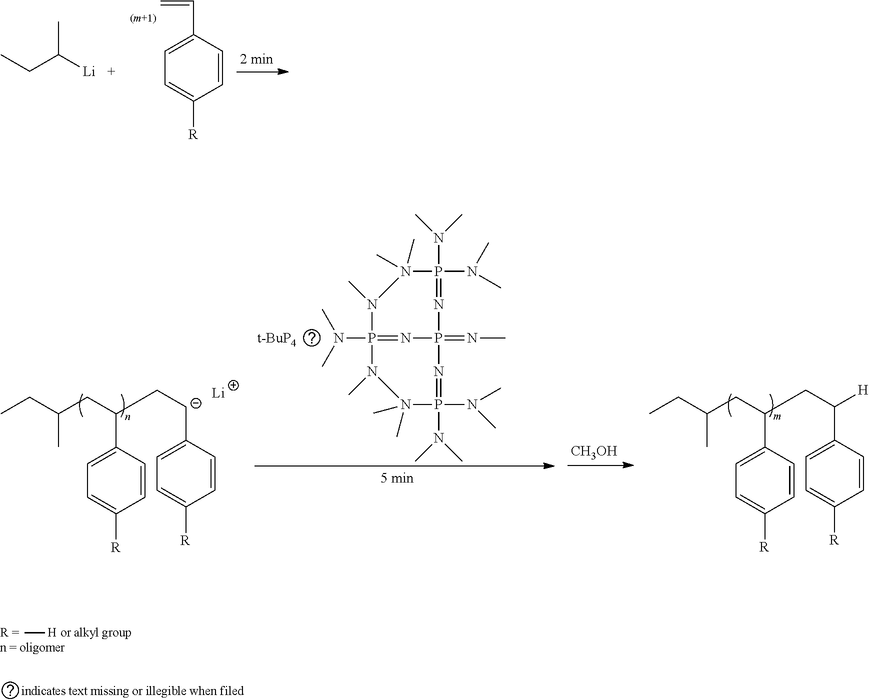

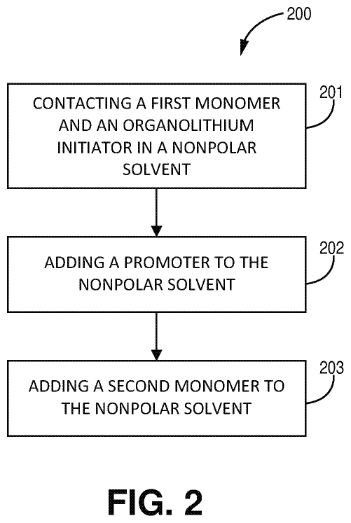

FIG. 2 is a flowchart of a method of synthesizing copolymers, according to one or more embodiments of the present disclosure. As shown in FIG. 2, the method 200 may comprise one or more of contacting 201 a first monomer and an organolithium initiator in a nonpolar solvent, adding 202 a promoter to the nonpolar solvent; and adding 203 a second monomer to the nonpolar solvent. In an embodiment, the promoter and organolithium initiator are provided in about equimolar amounts.

Each of the steps 201 to 203 may be performed in any order. For example, in an embodiment, the step 201 is performed first, the step 202 is performed second, and the step 203 is performed third. In an embodiment, the step 201 is performed first, the step 203 is performed second, and the step 202 is performed third. These shall not be limiting as other orders are clearly possible. In addition, the steps 201 and 202 may proceed as described above, the discussion of which is hereby incorporated by reference in its entirety.

The step 203 includes adding a second monomer. In this step, the second monomer is added to the nonpolar solvent, which may include at least the “living” polymer and optionally one or more of the other species from the steps of 201 and 202. Upon the addition of the second monomer, the “living” chain end of the resulting polymer from steps 201 and/or 202 may continue to grow through chain propagation with the second monomer. The second monomer may be selected to form one or more of homopolymers and copolymers (e.g., diblock copolymers). In an embodiment, the second monomer is the same as the first monomer (e.g., to form homopolymers or copolymers with polymer blocks formed from the same monomers). In an embodiment, the second monomer is different from the first monomer (e.g., to form copolymers, such as block copolymers). The second monomer may include any of the first polymers described herein. For example, in an embodiment, the second monomer may include, among others, one or more of styrenic monomers and other monomers, such as conjugated dienes (e.g., 1,3-butadiene and/or isoprene).

The polymerization of the second monomer may proceed in a manner that is similar to or the same as the polymerization of the first monomer. For example, the polymerization may be allowed to proceed until the second monomer is fully or partially consumed. In an embodiment, a conversion of greater than about 99% may be achieved in about 5 min or less. In other embodiments, the conversion may take longer. For example, a conversion of greater than about 99% may be achieved in about 10 h or less, such as about 8 h or less and/or about 4 h or less. The polymerization may proceed with side reactions kept to a minimum, or to an extent such that they are undetectable and/or negligible. The resulting polymers (e.g., homopolymers and/or copolymers) may exhibit narrow molecular weight distributions and/or predictable molecular weights.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### Example 1

### Ultrafast Phosphazene-Promoted Controlled Anionic Polymerization of Styrenic Monomers

The anionic polymerization of styrenic monomers with phosphazene bases as promoters, utilizing a “seeding” technique in a non-polar solvent and at about room temperature was studied. In every case, the phosphazene bases (t-BuP₄, t-BuP₂ and t-BuP₁) were added in an equimolar amount to the organolithium initiator after the formation of oligomers (about 2 min) by conventional anionic polymerization. When t-BuP₄ was used, the polymerization of styrene and 4-methylstyrene was extremely fast (about 5 min) and the final homopolymers exhibited narrow molecular weight distribution and controlled molecular characteristics. Likewise, when weaker bases were employed, the polymerization was also controlled, but exhibited slower reaction rates. To examine the “livingness” of this system, block copolymers were synthesized by sequential monomer addition. Further studies were conducted in order to extend this novel method to the anionic polymerization of dienes.

The present Example relates to the ultrafast anionic polymerization of styrene and 4-methylstyrene using t-BuP₄ as promoter in a non-polar solvent at room temperature via high vacuum techniques. Additionally, the anionic polymerization of styrene with other phosphazene bases (t-BuP₁, t-BuP₂) was examined and the “livingness” of these systems by synthesizing block copolymers with styrene and 1,3-butadiene was explored. This strategy led to the one-pot synthesis of well-defined homopolymers and copolymers with controlled molecular characteristics.

### EXPERIMENTAL

### Materials

1-tert-butyl-4,4,4-tris(dimethylamino)-2,2-bis [tris(dimethylamino) phosphoranyli-denamino]-2λ⁵,4λ⁵-catenadi-(phosphazene) (t-BuP₄, 0.8 M in hexane, Sigma-Aldrich), 1-tert-butyl-2,2,4,4,4-pentakis(dimethylamino)-2λ⁵,4λ⁵-catenadi-(phosphazene) (t-BuP₂, 2.0 M in THF, Sigma-Aldrich) and tert-butylimino-tris(dimethylamino)phosphorane (t-BuP₁, Sigma-Aldrich, 97%) were used as received. sec-Butyllithium (1.4 M in cyclohexane, Sigma-Aldrich) was diluted to an appropriate concentration in purified benzene, in a specific glass apparatus. Styrene (Sigma-Aldrich, 99%) and 4-methylstyrene (Sigma-Aldrich, 96%) were purified via consecutive distillations over CaH₂ (Sigma-Aldrich, 95%) and dibutyl-magnesium (1 M in heptane, Sigma-Aldrich) and stored in pre-calibrated ampoules. 1,3-Butadiene (Sigma-Aldrich, 99%) was purified via consecutive distillations over n-BuLi, at −10° C. using ice/salt bath, prior addition to the polymerization reactor. Benzene (Sigma-Aldrich, 99.8%) was purified via distillation from CaH₂ and stored in round bottom flask, under high vacuum. Methanol (Sigma-Aldrich, 99.8%) (terminating agent) was stored under high vacuum and used as received. N,N,N′,N′-Tetramethylethylenediamine (TMEDA, Sigma-Aldrich, ≥99.5%) was distilled over sodium mirror, diluted to an appropriate concentration in purified benzene and stored in pre-calibrated ampoules.

### Instruments

The number average molecular weight (Mₙ) and the polydispersity index (Ð) were determined via size exclusion chromatography (SEC) equipped with an isocratic pump, Styragel HR2 and HR4 columns in series (300×8 mm), a refractive index detector and THF as the eluent, at a flow rate of 1 mL/min, at 30° C. The calibration was performed using polystyrene standards (Mₚ: 370 to 4 220 000 g/mol). ¹H-NMR spectroscopy measurements were carried out using CDCl₃ (Sigma-Aldrich, 99.6%) on a Brücker AV-500 spectrometer. The obtained spectra were used to calculate the monomer conversion as well as the microstructure of the synthesized polydienes after integration of the corresponding chemical shifts. Matrix-assisted Laser Desorption/Ionization time-of-flight Mass Spectroscopy (MALDI-ToF MS) experiments were carried out by using [1,8-dihydroxy-9(10H)-anthracenone; dithranol] as the matrix and silver trifluoroacetate (cationizing agent) on a Bruker Ultrafex III MALDI-TOF mass spectrometer (Bruker Daltonik, Bremen, Germany). In general, mass spectra from 256 laser shots were accumulated and summed to produce a final spectrum.

### Polymerization Via “Seeding” in the Presence of Phosphazene Bases

All polymerizations were carried out via high vacuum techniques, using custom-made glass reactors, equipped with break-seals for the addition of the reagents and constrictions for the removal of aliquots. A typical procedure was as follows. In an evacuated and n-BuLi washed glass reactor, containing about 70 mL of benzene, about 2.2 mL of styrene (about 2 g) and about 0.25 mmol of sec-BuLi were added at about room temperature. After about 2 min, an aliquot was taken and about 0.25 mmol of t-BuP₄ was added and the reaction left to proceed. Small aliquots were withdrawn from the solution frequently in order to determine the conversion, the molecular weight, and the polydispersity. Finally, the reaction was quenched by adding methanol (˜1 mL) and the solution precipitated in a large excess of methanol. The white powder was collected and dried in a vacuum oven for two days (Mₙ=8,000 g/mol, Ð=1.11). The same synthetic procedure was followed using t-BuP₂, t-BuP₁ and TMEDA as additives for the polymerization of styrene as well as in the case of the polymerization of 4-methylstyrene and 1,3-butadiene via seeding.

### Sequential Addition of Styrene or 1,3-Butadiene to the “Living” PS Synthesized Via Seeding

A typical procedure was as follows. To a “living” PS (Mₙ=4,500 g/mol) (Table 3, Entry 2) synthesized by the previously described method, about 1.4 mL of 1,3-butadiene was added and the polymerization left to proceed at about room temperature. The next day the polymerization quenched by adding methanol, the mixture precipitated in excess of methanol and finally collected and dried in a vacuum oven for about two days (M_{n,PB}^{NMR}=1,300 g/mol, Ð=1.32). The same synthetic protocol was followed for the sequential copolymerization of 1,3-butadiene, using t-BuP₂ and t-BuP₁ phosphazene bases and also for the polymerization of styrene using t-BuP₄.

TABLE 3
Molecular characteristics of PS-b-PS′ and PS-b-PB (co) polymers [(PS synthesized vis “seeding”
and use of phosphazene bases (1:1 molar ratio to sec-BuLi)] by sequential monomer addition.

| | | | | | | | | Time (100% |
|---|---|---|---|---|---|---|---|---|
| | | Phosphazene | Mₙ^{PS a} | | Mₙ^{2nd block} | Mₙ^{2nd block (theor.)} | | conversion) |
| Entry | Sample | Base (PB) | (g/mol) | Ðₚₛ ^{a} | (g/mol) | (g/mol) | Ðₜₒₜ ^{a} | (min) |
| 1 | PS-b-PS′ | t-BuP₄ | 4,700 | 1.13 | 6,000 ^{a} | 5,000 | 1.09 | 5 |
| 2 | PS-b-PB | t-BuP₄ | 4,500 | 1.11 | 1,300 ^{b} | 5,000 | 1.32 | — |
| 3 | PS-b-PB | t-BuP₂ | 22,000 | 1.04 | 25,300 ^{b} | 13,800 | 1.12 | 240 |
| 4 | PS-b-PB | t-BuP₁ | 8,600 | 1.05 | 19,000 ^{b} | 10,000 | 1.09 | 480 |

^{a} Number-average molecular weight of polystyrene and polydispersity index calculated by SEC, using THF as a solvent and calibrated with PS standards.
^{b} Number-average molecular weight of polybutadiene calculated by ¹H-NMR (500 MHz) in CDCl₃ at room temperature.

### Polymerization of Styrene Via Seeding Using “Living” PB as Macroinitiator

The anionic polymerization of 1,3-butadiene was conducted in benzene with sec-BuLi as initiator using high-vacuum techniques in evacuated, n-BuLi washed and benzene rinsed glass reactors. A typical procedure was as follows, about 2 mL of 1,3-butadiene and about 1.24 mL (about 0.124 mmol) of sec-BuLi were added to about 50 mL of benzene and the reaction left to proceed for about 24 h. After the polymerization of 1,3-butadiene, an aliquot was removed from the apparatus for characterization with SEC (M_{n,theor}=10.000 g/mol, M_{n,NMR}=9.300 g/mol, Ð=1.03). Subsequently, about 1 mL of styrene was added first, left to react with “living” PB for about 10 min and then about 0.124 mmol of t-BuP₄ was added. The polymerization left to complete for about 1 h (M_{n,theor}^{PS}=7,300, M_{n,SEC}^{PS}=7,000 g/mol, Ð_{diblock}=1.06).

### Results and Discussion

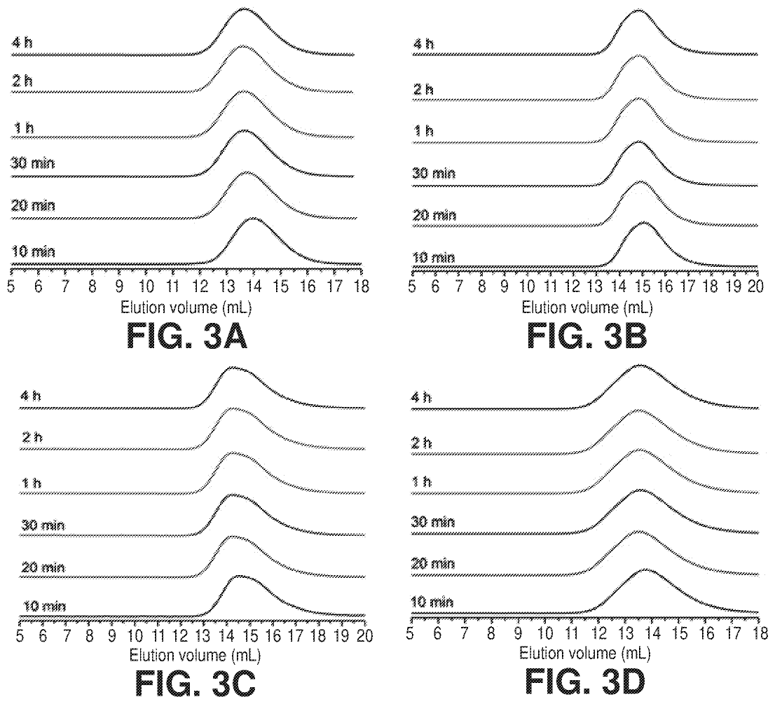

It has been shown that the rate of polymerization of styrene, initiated by carbanionic initiators, is accelerated in the presence of Lewis bases, such us ethers and amines. In a previous study, the anionic polymerization of styrene, in benzene at about room temperature, with sec-BuLi in the presence of phosphazene superbases (t-BuP₄, t-BuP₂ and t-BuP₁) at phosphazene/sec-BuLi: about 0.5 (t-BuP₂ and t-BuP₁) and about 1 (t-BuP₄, t-BuP₂ and t-BuP₁) ratios, was studied. In the case of t-BuP₂ and t-BuP₁, the results were comparable to the ones published for Lewis bases. However, in the case of t-BuP₄ (1:1), although the polymerization was fast, it was uncontrolled leading to polystyrene with broad polydispersity index (Ð>1.9) and ten times higher molecular weight than the theoretical one. This was probably due to the formation of the extremely reactive sec-Bu⁻ free anion, since Li⁺ was trapped by the superbase {sec-Bu⁻[(t-BuP₄)Li⁺]}, and thus the propagation rate (Rₚ) compared to the initiation rate (Rᵢ), was much higher leading to uncontrollable polymerization. The same trend, Rₚ>>>Rᵢ was observed, in new experiments, when different t-BuP₄/sec-BuLi: about 2.5, 5, 10, 20 molar ratios were used (Table S1, FIGS. 3A-3D). Accordingly, as described herein, a “seeding” technique was used for the anionic polymerization, in order to balance Rᵢ with Rₚ.³⁶

### Polymerization Via “Seeding” in the Presence of Phosphazene Bases

Firstly, styrene was left to polymerize in benzene, with sec-BuLi, only for about 1-2 min to afford oligomers (“seeds”) and not the final polymer. Subsequently, an about equimolar amount of t-BuP₄ to sec-BuLi was added and the polymerization was left to proceed until full consumption of the monomer. Finally, methanol was added to terminate the reaction (Scheme 1). A ratio of t-BuP₄/sec-BuLi=1 was used, since same results were obtained with other ratios (Table 51, FIGS. 3A-3D).

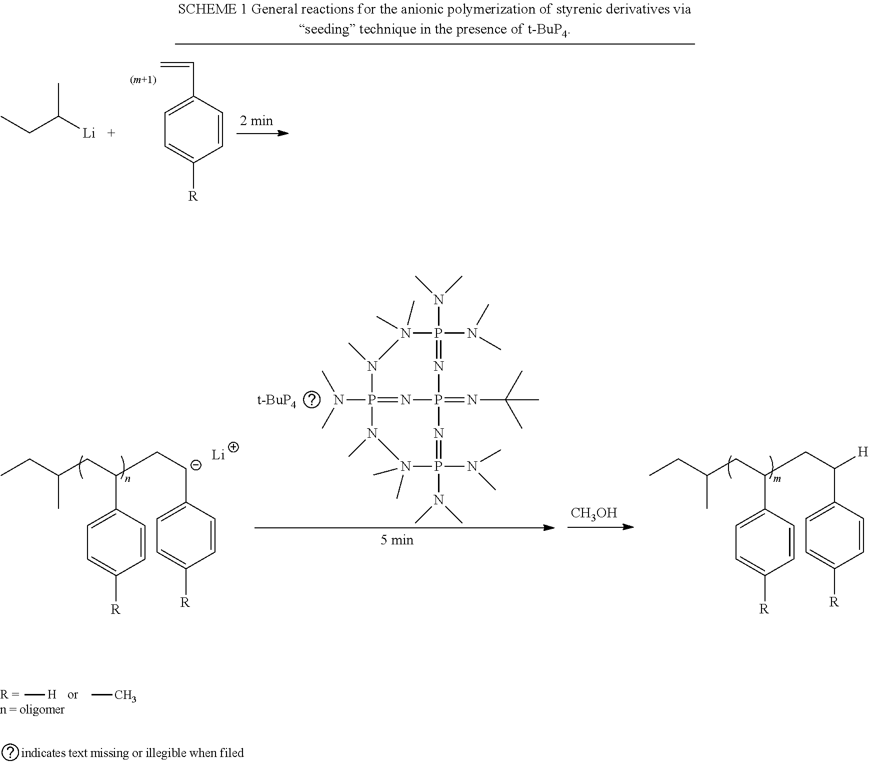

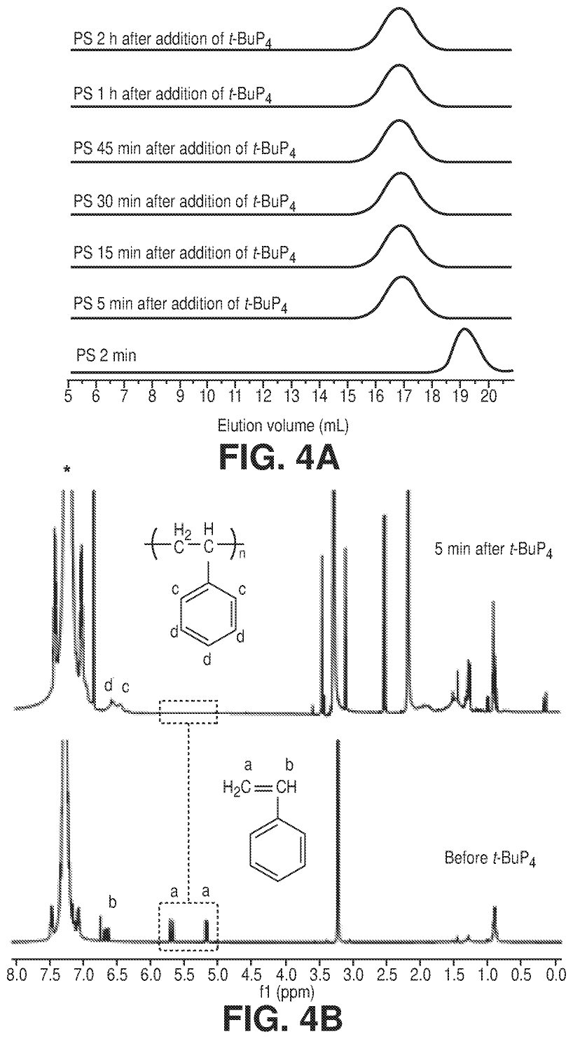

To explore the utility of this system, the ability to target higher degree of polymerization (Table 1) was investigated. In all cases, the final polymers were characterized by narrow molecular weight distribution (Ð≤1.11) and the molecular weights were similar to the targeted ones (FIG. 4A). Interestingly, the “seeding” technique was used in anionic polymerization in order to balance Rᵢ with Rₚ.

TABLE 1
Molecular characteristics of polystyrene synthesized by anionic
polymeriation and use of t-BuP₄ via “seeding”.

| | | | | | | Time (after |
|---|---|---|---|---|---|---|
| | | | | | | addition of |
| | | t-BuP₄/sec- | Mₙ^{target} | Mₙ ^{b} | | t-BuP₄) |
| Entry | Sample | BuLi ^{a} | (g/mol) | (g/mol) | Ð ^{b} | (min) |
| 1 | PS-1 | 1:1 | 7,000 | 7,200 | 1.11 | 5 |
| 2 | PS-2 | 1:1 | 20,000 | 21,400 | 1.10 | 5 |
| 3 | PS-3 | 1:1 | 45,000 | 45,500 | 1.08 | 5 |

^{a} Molar ratio of sec-BuLi and t-BuP₄;
^{b} Number-average molecular weight of polydispersity index calculated by SEC, using THF as a solvent and calibrated with PS standards.

### Polymerization Via “Seeding” in the Presence of Phosphazene Bases

Firstly, styrene was left to polymerize in benzene, with sec-BuLi, only for about 1-2 min to afford oligomers (“seeds”) and not the final polymer. Subsequently, an about equimolar amount of t-BuP₄ to sec-BuLi was added and the polymerization was left to proceed until full consumption of the monomer. Finally, methanol was added to terminate the reaction (Scheme 1). A ratio of t-BuP₄/sec-BuLi=1 was used, since same results were obtained with other ratios (Table 51, FIGS. 3A-3D).

To explore the utility of this system, the ability to target higher degree of polymerization (Table 1) was investigated. In all cases, the final polymers were characterized by narrow molecular weight distribution (Ð≤1.11) and the molecular weights were similar to the targeted ones (FIG. 4A). Interestingly, the polymerization reactions were completed about 5 min after the addition of the t-BuP₄ as revealed by ¹H NMR spectroscopy (FIG. 4B).

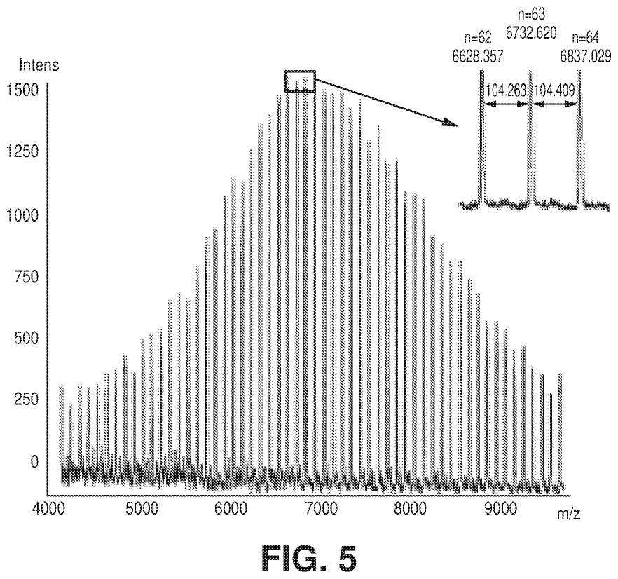

The acceleration of the polymerization was attributed to the high reactivity of the sec-Bu⁻ free anions, while the “seeding” was important for balancing the propagation and initiation rates and to avoid products with high molecular weight distribution. It should be noted that conventional anionic polymerization of styrene initiated by organolithium compounds, in hydrocarbon solvents, and at room temperature reaches 99% conversion after 3 h. The final product (Table 1, Entry 1) was further characterized by MALDI-ToF. As shown in FIG. 5, only one narrow and symmetrical population was detected and the peak-to-peak mass difference of 104 corresponding exactly to the molar mass of the monomeric unit.

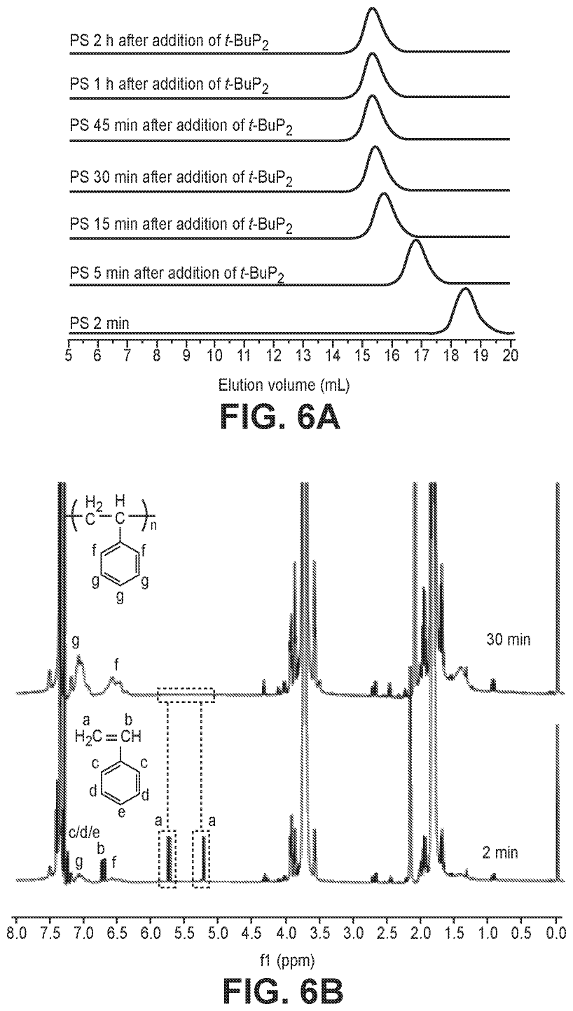

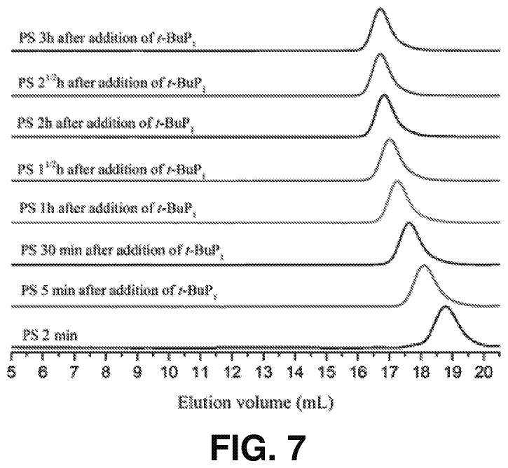

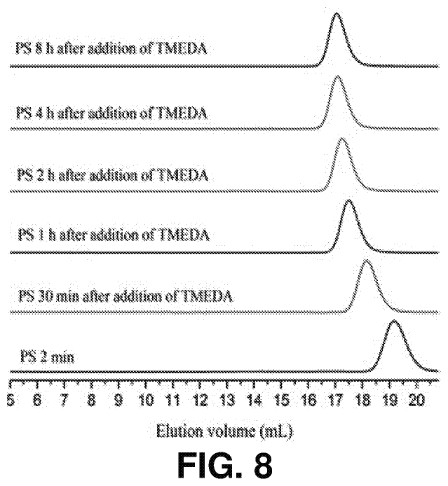

To examine how the basicity of the superbase affects the polymerization rate of styrene via “seeding”, t-BuP₁, t-BuP₂ along with TMEDA were applied under same or similar conditions (additive/sec-BuLi molar ratio and solution concentration) (Table 2). As expected, the final products were characterized by narrow molecular weight distributions (Ð≤1.05) and the theoretical molecular weights were in good agreement with the experimental ones. Nevertheless, when t-BuP₂ and t-BuP₁ were used (Table 2, Entries 1,2), the polymerization completed after about 30 and about 110 min respectively (FIGS. 6A-6B, FIG. 7) due to the lower basicity, compared to t-BuP₄, leading to a significant decrease of the propagating site reactivity. When TMEDA was used, the monomer was consumed after about 130 min, faster than the conventional anionic polymerization of styrene, due to the decrease or even elimination of the association of polymeric organolithium chain ends (FIG. 8).

TABLE 2
Molecular characteristics of polystyrene synthesized by anionic polymeriation,
“seeding” and use of phosphazene bases end TMEDA.

| | | | | | | | Time (100% |
|---|---|---|---|---|---|---|---|
| | | | Additive/sec- | Mₙ^{target} | Mₙ ^{b} | | conversion) |
| Entry | Sample | Additive | BuLi ^{a} | (g/mol) | (g/mol) | Ð ^{b} | (min) |
| 1 | PS-1 | t-BuP₁ | 1:1 | 9,000 | 8,600 | 1.05 | 110 |
| 2 | PS-2 | t-BuP₂ | 1:1 | 20,000 | 20,500 | 1.04 | 30 |
| 3 | PS-3 | TMEDA | 1:1 | 3,000 | 7,600 | 1.05 | 130 |

^{a} Molar ratio;
^{b} Number-average molecular weight and polydispersity index calculated by SEC, using THF as a solvent and calibrated with PS standards.

Based on these findings, it was interesting to utilize this approach with other styrenic monomers bearing alkyl side groups, such as 4-methylstyrene (4MS). The conventional polymerization of the above-mentioned monomers is conducted at low temperatures (0° C. to −70° C.) and terminated at low conversion, in order to avoid chain transfer reactions, involving initiator or growing chain ends and p-alkyl groups of the monomer and polymer.

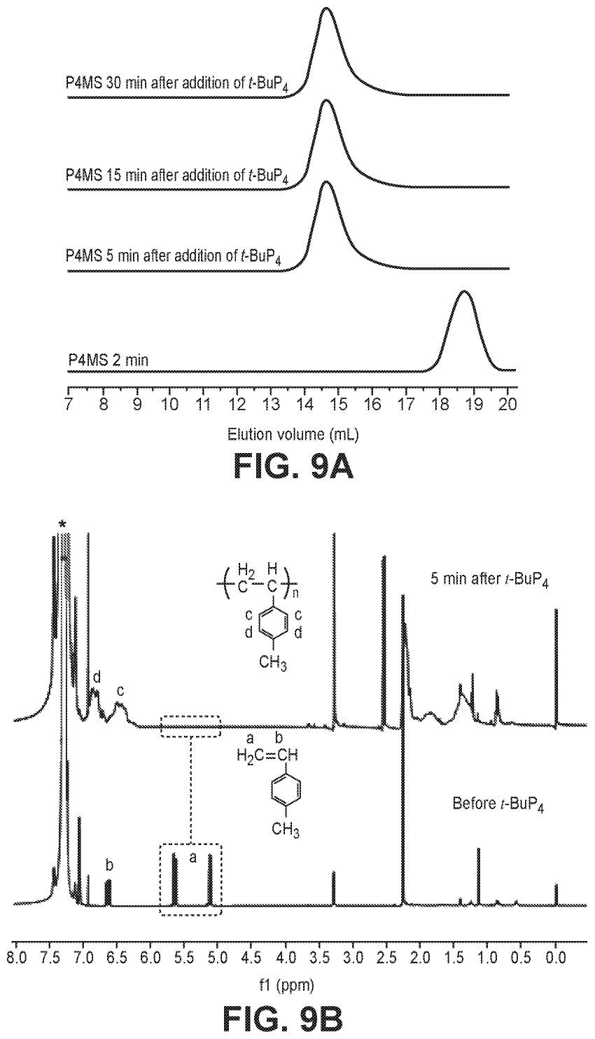

Interestingly, when “seeding” technique was employed for 4-methylstyrene at room temperature, in the presence of equimolar amount of sec-BuLi and t-BuP₄, the polymerization completed after about 5 min, following the same trend as in the case of styrene (FIGS. 9A-9B). The final poly(4-methylstyrene) was characterized by narrow distribution (Ð=1.12) and nearly predictable molecular weight (Mₙ^{thor.}=25,000 g/mol, Mₙ^{exper.}=20,000 g/mol). Apparently, the high reactivity of the anionic species accelerated so much the polymerization rate without leaving time for the side reaction to occur.

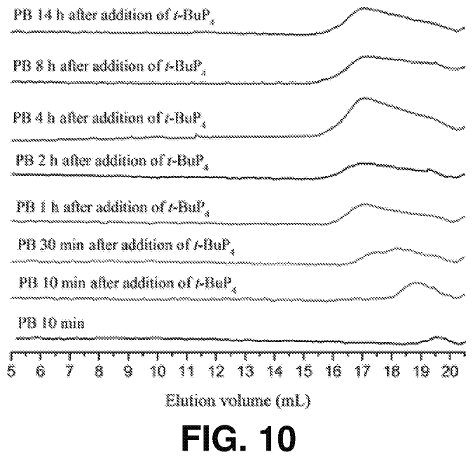

The same protocol was also used for the homopolymerization of the 1,3-butadiene but the polymerization was uncontrolled (Ð=1.72, Mₙ^{theor.}=20,000 g/mol, Mₙ^{exper.}=3,200 g/mol) and the conversion was low (<40%) even after about 14 h (FIG. 10). This was probably due to spontaneous and isomerization destruction reactions which are common in “living” poly(diene) solutions in the presence of even mild polar additive as tetrahydrofuran.

### Sequential Addition of Styrene or 1,3-Butadiene to the “Living” PS Synthesized Via Seeding.

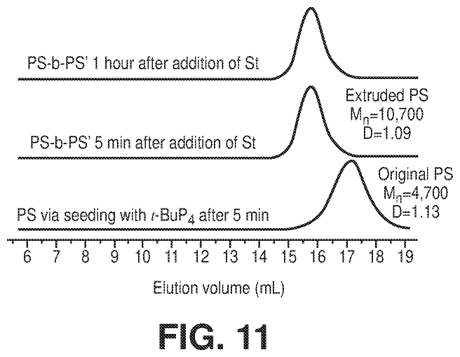

The “livingness” of the PS synthesized via seeding with t-BuP₄ was verified by the sequential polymerization of a second monomer (Table 3). Firstly, a new amount of styrene was added when the initial styrene was fully consumed (about 5 min after the addition of t-BuP₄). The SEC trace of the final product was shifted to lower elution volume with narrow distribution (Ð=1.09) (FIG. 11), while the second amount of styrene was also consumed in about 5 min. Importantly, the total number average molecular weight of the extended PS (Mₙ^{exper}=10,700 g/mol) was practically the theoretical value (Mₙ^{theor.}=10,000 g/mol) (Table 3, Entry 1). Even though is impossible to implement kinetic studies due to the short period of time, all of the above features indicated the “living” character of the polymerization.

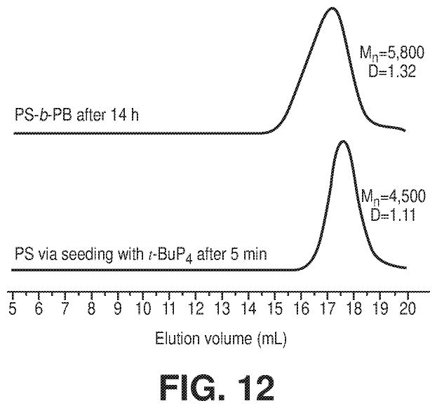

Additionally, 1,3-butadiene was utilized as the second monomer with PS as macroinitiator synthesized via seeding with t-BuP₄ (Table 3, Entry 2). The final block copolymer showed relatively broad polydispersity (Ð=1.32), low monomer conversion (<40%) and molecular weight M_{n,exper. NMR}=1,300 g/mol, while the targeted molecular weight for the second block was about 5,000 g/mol (FIG. 12). This uncontrolled polymerization was attributed to isomerization reactions as described above.

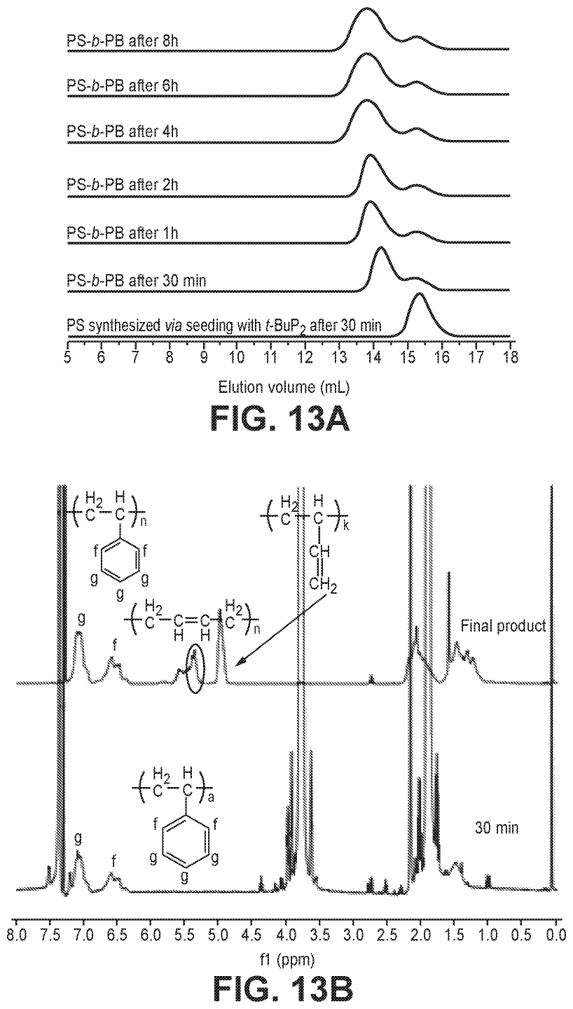

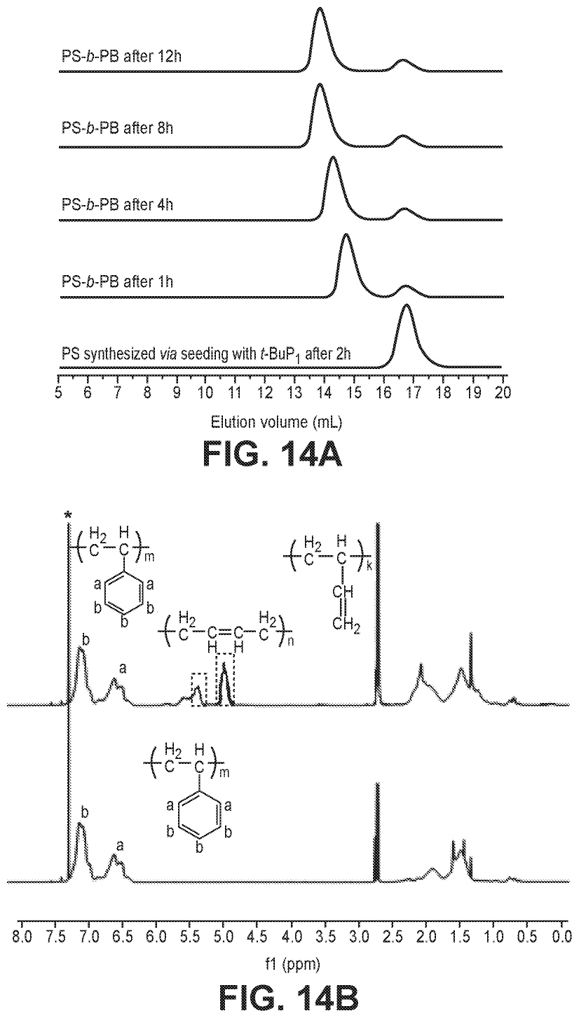

In the case of butadiene, these undesirable reactions were reduced, but not eliminated, when seeding took place and t-BuP₂ was used as additive (Table 3, Entry 3). Styrene was first polymerized (seeding and t-BuP₂), after the complete consumption of the monomer (about 30 min), 1,3-butadiene was added. The polymerization completed after about 4 h and the SEC trace of the final diblock copolymer showed a bimodal molecular weight distribution (FIGS. 13A-13B). The same trend was observed when t-BuP₁ was used except that the polymerization completed after about 8 h (Table 3, Entry 4, FIGS. 14A-14B).

### Polymerization of Styrene Via Seeding Using “Living” PB as a Macroinitiator.

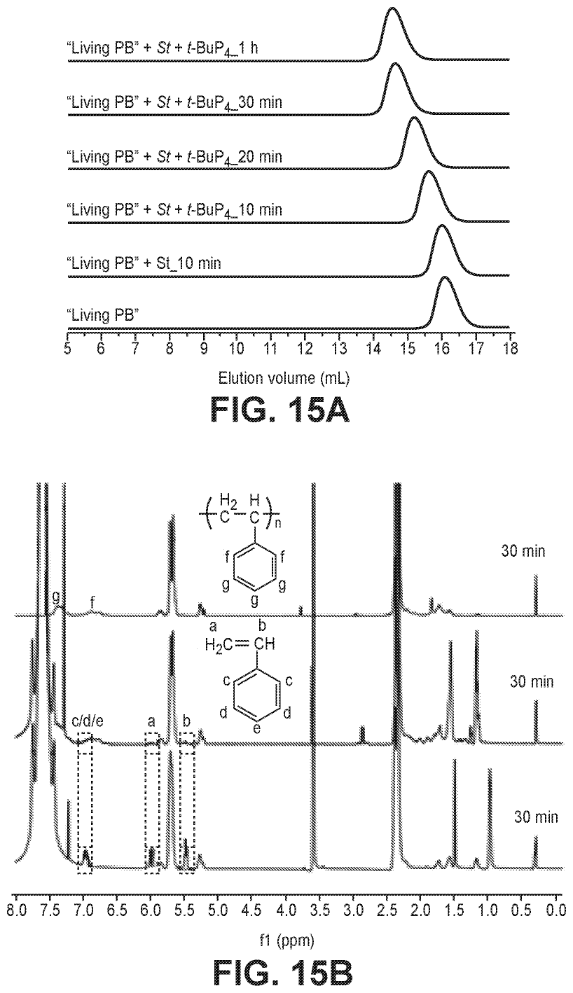

To examine if the “seeding” technique in the presence of t-BuP₄ can be employed when a “living” macroanion is used instead of sec-BuLi, styrene was added in a solution of PB⁻Li⁺. After about 10 min an equimolar amount of t-BuP₄ to PB⁻Li⁺ was added and the polymerization left to proceed. NMR spectra showed that after about 30 min, about 95% of the styrene was consumed (FIGS. 15A-15B). The final diblock copolymer had a narrow polydispersity (Ð=1.06) and molecular weight equal to about 16,300 g/mol, close to the theoretical one (Mₙ^{diblock,theor.}=17,300 g/mol). The slower polymerization rate compared to the one obtained by seeding with sec-BuLi as initiator, was attributed to association phenomena of PB⁻Li⁺ in benzene. Nevertheless, the polymerization of the second block was still faster than the conventional anionic polymerization of styrene.

### CONCLUSIONS

In summary, when a strong phosphazene base (t-BuP₄) was used as a promoter in anionic polymerization initiated by an organolithium compound, the polymerization was extremely fast but uncontrolled due to the high reactivity of the formed carbanions. In order to overcome this drawback, a facile method combining phosphazene bases, organolithium initiator and the “seeding” technique was described. Specifically, the addition of t-BuP₄ after the formation of oligomers (seeds) led to the ultrafast anionic polymerization of styrene. All the monomers were consumed after only about 5 min and the obtained homopolymers exhibited the desired molecular weights and narrow polydispersity. This method was successfully employed for the polymerization of 4-methylstyrene in a hydrocarbon solvent at room temperature, where the polymerization rate was extremely fast thus suppressing potential chain transfer reactions to the p-methyl group of the monomer. The further addition of styrene to the PS⁻[(t-BuP₄)Li⁺] confirmed the “livingness” of our system, since PS-b-PS′ was obtained with controlled molecular characteristics after 5 min. Preliminary experiments on the polymerization of 1,3-butadiene showed that this strategy was not suitable for the controlled synthesis of polydienes due to isomerization reactions. To conclude, this novel method might have an impact not only on academia but also in the industry since well-defined polymers are produced within minutes rendering the manufacturing process more cost-effective.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

Various examples have been described. These and other examples are within the scope of the following claims.

1. A method of synthesizing a polymer, comprising:
contacting a first monomer and an organolithium initiator in a nonpolar solvent to form oligomers; and
adding a phosphazene superbase as a promoter to the nonpolar solvent to accelerate chain propagation;
wherein the promoter and organolithium initiator are provided in about equimolar amounts.

2. The method of claim 1, wherein the contacting proceeds for about 2 minutes or less at about room temperature.

3. The method of claim 1, wherein the contacting forms oligomers without forming a detectable amount of polymers.

4. The method of claim 3, wherein the oligomers include a propagating anionic species and a lithium counterion.

5. The method of claim 1, wherein the first monomer includes one or more of styrene, 4-methylstyrene; alpha-methylstyrene; 1-vinylnaphthalene; 2-vinylnaphthalene; 1-alpha-methylvinylnaphthalene; 2-alpha-methylvinylnaphthalene; 1,2-diphenyl-4-methylhexane-1; 1,6-diphenyl-hexadiene-1,5; 1,3-divinylbenzene; 1,3,5-trivinylbenzene; 1,3,5-triisopropenylbenzene; 1,4-divinylbenzene; 1,3-distyrylbenzene; 1,4-distryrylbenzene; 1,2-distyrylbenzene; 3-methylstyrene; 3,5-diethylstyrene; 2-ethyl-4-benzylstyrene; 4-phenylstyrene; 4-p-tolylstyrene; 2,4-divinyltoluene; 4,5-dimethyl-1-vinylnaphthalene; 2,4,6-trivinyltoluene; 2,4,6-triisopropenyltoluene; mixtures thereof, and derivatives thereof.

6. The method of claim 1, wherein the first monomer includes one or more of 1,3-butadiene, isoprene, 2,3-dimethyl-1,3-butadiene, 1,3-pentadiene (piperylene), 2-methyl-3-ethyl-1,3-butadiene, 3-methyl-1,3-pentadiene, 2-methyl-3-ethyl-1,3-pentadiene, 2-ethyl-1,3-pentadiene, 1,3-hexadiene, 2-methyl-1,3-hexadiene, 1,3-heptadiene, 3-methyl-1,3-heptadiene, 1,3-octadiene, 3-butyl-1,3-octadiene, 3,4-dimethyl-1,3-hexadiene, 3-n-propyl-1,3-pentadiene, 4,5-diethyl-1,3-octadiene, phenyl-1,3-butadiene, 2,3-diethyl-1,3-butadiene, 2,3-di-n-propyl-1,3-butadiene, and 2-methyl-3-isopropyl-1,3-butadiene.

7. The method of claim 1, wherein the organolithium initiator includes one or more of n-butyllithium, sec-butyllithium, tert-butyllithium, methyllithium, ethyllithium, n-propylllithium, isopropyllithium, n-butyllithium, isobutyllithium, sec-butyllithium, tert-butyllithium, n-amyllithium, isoamyllithium, n-pentyllithium, n-hexyllithium, 2-ethylhexyllithium, n-octyllithium, n-decyllithium, stearyllithium, allyllithium, n-propenyllithium, isobutenyllithium, 1-cyclohexenyllithium, cyclopentyllithium, cyclohexyllithium, cyclohexylethyllithium, phenyllithium, naphthyllithium, vinyl lithium, tolyllithium, butylphenyllithium, benzyllithium, phenylbutyllithium, tetramethylenedilithium, pentamethylenedilithium, hexamethylenedilithium, diphenylethylenedilithium, tetraphenylethylenedilithium, 1,5-dilithium naphthalene, 1,20-dilithioeicosane, 1,4-dilithiocyclohexane, and dilithiostylbene.

8. The method of claim 1, wherein the nonpolar solvent includes one or more of benzene, cyclohexane, toluene, hexane, pentane, and cyclopentane.

9. The method of claim 4, wherein the promoter complexes with the lithium counterion.

10. The method of claim 1, wherein the promoter includes one or more of t-BuP₄, t-BuP₂, t-BuP₁, cyclic trimeric phosphazene base (CTPB), branched or linear t-BuP₃, branched or linear t-BuP₅, PyP₄, and t-BuP₇.

11. The method of claim 1, wherein a conversion of greater than about 99% is achieved within about 5 minutes of the adding.

12. The method of claim 1, wherein a molecular weight distribution of the polymers is about 1.10 or less.

13. The method of claim 1, wherein an average molecular weight of the polymers is within about 5% of a target molecular weight.

14. The method of claim 1, wherein the polymer is synthesized without forming detectable amounts of products from side reactions.

15. The method of claim 1, wherein the rate of initiation is greater than the rate or propagation.

16. The method of claim 1, further comprising adding an agent to quench the reaction.

17. A method of synthesizing a polymer, comprising:
contacting a first monomer and an organolithium initiator in a nonpolar solvent to form oligomers;
adding a phosphazene superbase as a promoter to the nonpolar solvent to accelerate chain propagation; and
adding a second monomer to the nonpolar solvent to form the polymer, wherein the promoter and organolithium initiator are provided in about equimolar amounts.

18. The method of claim 17, wherein the first monomer and the second monomer are the same.

19. The method of claim 17, wherein the first monomer and the second monomer are different.

20. The method of claim 17, wherein the synthesized polymer is a diblock copolymer.
